(19) United States
(12) Patent Application Publication
(10) Pub. No.: US 2006/0152331 A1
(43) Pub. Date: Jul. 13, 2006

(54) PTC current limiting device having flashover prevention structure

(76) Inventors: Jong-Sung Kang, Cheongju-si (KR); Ju-Dam Kim, Seoul (KR); Bang-Wook Lee, Cheongju-si (KR); Jong-Hwan Lee, Seongnam-si (KR); Won-Joon Choe, Cheongju-si (KR)

Correspondence Address: JONES DAY, 222 EAST 41ST ST, NEW YORK, NY, 10017, US

(21) Appl. No.: 11/330,516

(22) Filed: Jan. 11, 2006

(30) Foreign Application Priority Data
Jan. 12, 2005 (KR) KR10-2005-0003044

(51) Int. Cl. H01C 7/13

(52) U.S. Cl. 338/22 R; 338/22 SD

(57) ABSTRACT

Disclosed is a PTC (Positive Temperature Coefficient) current limiting device, which limits a current using PTC characteristics. The device includes a PTC element having the PTC characteristics; and upper and lower contact electrodes arranged to face each other with the PTC element being interposed therebetween, wherein, assuming that a distance from an end of the upper contact electrode to an end of the PTC element is a1, a distance from an end of the lower contact electrode to the end of the PTC element is a2, a thickness of the PTC element is b, and L=a1+a2+b, the following equations are satisfied: V/L<10 and V/b<50, where V is a rated voltage of the PTC current limiting device, a unit for a1, a2 and b is mm, and a unit for V is volt. This PTC current limiting device may prevent generation of flashover between electrodes.

### BACKGROUND OF THE INVENTION

1. Field of the Invention

The present invention relates to a current limiting device, and more particularly to a PTC (Positive Temperature Coefficient) current limiting device using a PTC element to prevent flashover between contact electrodes in the current limiting device.

2. Description of the Related Art

Generally, a circuit breaker is widely used for preventing a short circuit of a high or low voltage system. However, a conventional circuit breaker takes a long time for circuit breaking, and does not have a current limiting function against an estimated fault current value, so a ripple effect for the fault is lasting relatively longer. In addition, in case of failing to break a short circuit current, serious effects are given to surrounding power equipments and systems. Thus, there is an increased need for a current limiting device that is capable of effectively limiting a short circuit current of a system in a short time.

The current limiting device is used for limiting overcurrent or short circuit current generated in a power system, and it may achieve its function using PTC (Positive Temperature Coefficient) materials generally in a low-voltage, low-current region.

A material having the PTC characteristic has a relatively low resistance at a normal temperature to pass an electric current well. However, if a temperature of surroundings is increased or the material is heated by itself due to the introduction of a current over an allowable value, the resistance is abruptly increased several hundred times or more, thereby capable of limiting the current. Thus, if a circuit element is configured using the above material, various circuits may be protected when a temperature rises.

In this connection, Japanese Patent Publication H10-321413 discloses a current limiting device using PTC. Referring to FIG. 1 related to the above, the conventional PTC current limiting device includes a PTC polymer element 1 having PTC characteristics by mixing conductive particles therein, first electrodes 2, 3 arranged on both surfaces of the PTC polymer element 1 by welding, and second electrodes 4, 5 arranged on the surfaces of the first electrodes 2, 3 to be electrically connected thereto.

At this time, the current limiting device has conditions that the PTC polymer element 1 has a surface area greater than the first electrodes 2, 3, and the first electrodes 2, 3 have a surface area greater than the second electrodes 4, 5. In this configuration, an interior short circuit occurring at both ends of the first electrodes 2, 3 may be effectively prevented.

In this PTC current limiting device, an initial resistance of the PTC element 1 and the current density ensuring electric connection are decided according to the thickness of the PTC element 1 without tripping of the device, so the thickness of the PTC element I should be not so large in order to use the PTC current limiting device in a high-voltage, large-current power system. However, if the PTC element 1 has a small thickness, flashover is apt to be caused between the first electrodes 2, 3. Thus, it is preferred to select a PTC element 1 with a thin thickness not causing any flashover between the first electrodes 2, 3. That is to say, it is required to suggest optimal design conditions considering even a thickness factor of the PTC element 1, not designing a PTC current limiting device by simple comparison between the surface area of the PTC element 1 and the surface area of the first electrodes 2, 3.

### SUMMARY OF THE INVENTION

The present invention is designed to solve the problems of the prior art, and therefore it is an object of the present invention to provide a PTC current limiting device capable of preventing generation of flashover between contact electrodes of the PTC current limiting device by considering a thickness factor of a PTC element as well as a contact area factor between the PTC element and the contact electrodes.

In order to accomplish the above object, the present invention provides a PTC current limiting device, which limits a current using PTC characteristics, the device including a PTC element having the PTC characteristics; and upper and lower contact electrodes arranged to face each other with the PTC element being interposed therebetween, wherein, assuming that a distance from an end of the upper contact electrode to an end of the PTC element is a1, a distance from an end of the lower contact electrode to the end of the PTC element is a2, a thickness of the PTC element is b, and L=a1+a2+b, the following equations are satisfied:

$$\frac{V}{L} < 10 and \frac{V}{b} < 50 ,$$

where V is a rated voltage of the PTC current limiting device, a unit for a1, a2 and b is mm, and a unit for V is volt.

According to a preferred embodiment of the present invention, the PTC current limiting device may further include upper and lower current leads connected to the upper and lower contact electrodes respectively to electrically connect the contact electrodes to a system circuit.

The PTC element may include at lease one polymer selected from the group consisting of HDPE (High Density Polyethylene), LDPE (Low Density Polyethylene), epoxy, silicone, and PVDF (Polyvinyl Difluoride); at least one type of conductive particles selected from the group consisting of carbon, metal and metal oxide; and an antioxidant.

Preferably, the PTC element has a plate shape.

In another embodiment of the present invention, the PTC current limiting device may further include a pressing means for pressing the contact electrodes toward the PTC element.

Preferably, the pressing means gives a pressing force equal to or greater than an atmospheric pressure.

The pressing means may include a housing that receives the PTC element, the contact electrodes and the current leads; and an elastic member elastically biased by an inner surface of the housing so as to press the current leads toward the PTC element.

As an alternative, the pressing means may also include a pair of plates arranged so that the PTC element, the contact electrodes and the current leads are interposed therebetween; and a coupling member for coupling and fixing the pair of plates with each other. Preferably, the pressing member may further include an elastic member elastically biased by an inner surface of the plates so as to press the current leads toward the PTC element.

### BRIEF DESCRIPTION OF THE DRAWINGS

Other objects and aspects of the present invention will become apparent from the following description of embodiments with reference to the accompanying drawing in which:

FIG. 1 is a sectional view showing a conventional PTC current limiting device;

FIG. 2 is a perspective view showing a PTC current limiting device according to a preferred embodiment of the present invention;

FIG. 3 is a sectional view showing the PTC current limiting device of FIG. 2;

FIG. 4 is a sectional view showing a PTC current limiting device according to another embodiment of the present invention;

FIG. 5 is a sectional view showing a PTC current limiting device according to still another embodiment of the present invention;

FIG. 6 is a graph showing an operation waveform of the PTC current limiting device when a current limiting action is failed; and

FIG. 7 is a graph showing an operation waveform of the PTC current limiting device according to the present invention.

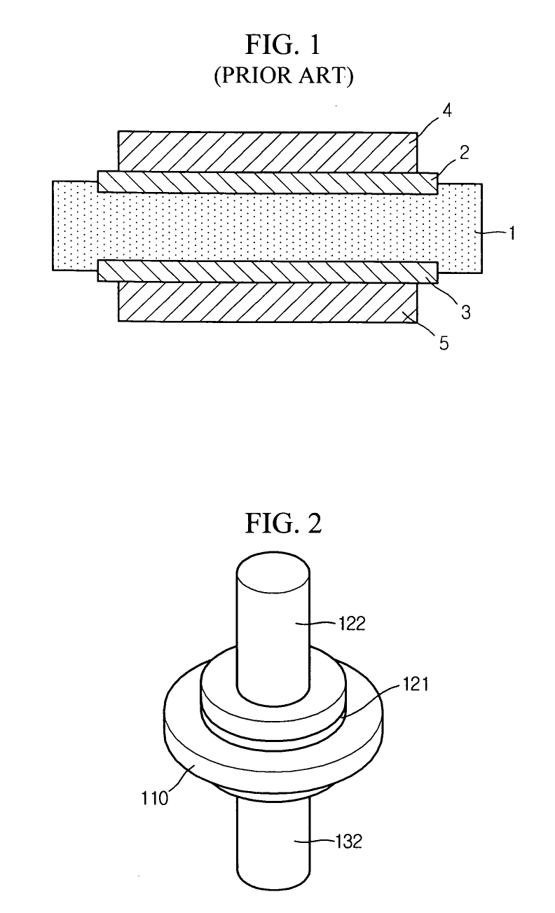

### DESCRIPTION OF THE PREFERRED EMBODIMENT

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

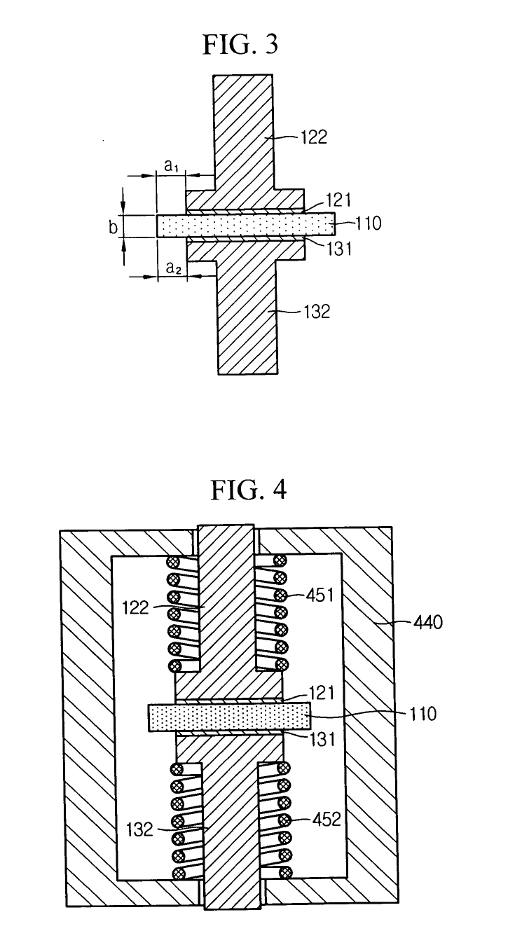

FIG. 2 is a perspective view showing a PTC (Positive Temperature Coefficient) current limiting device according to a preferred embodiment of the present invention, and FIG. 3 is a sectional view showing the PTC current limiting device of FIG. 2.

Referring to FIGS. 2 and 3, the PTC current limiting device of this embodiment includes a PTC element 110, and a pair of contact electrodes 121, 131 arranged to interpose the PTC element 110 between them.

The PTC element 110 restrains an overcurrent in a power system by abruptly increasing its electrical resistance at a specific temperature value as a temperature of the surroundings rises, as mentioned above.

The PTC element 110 have different properties according to a current value to be limited, but in this embodiment the PTC element 110 preferably has a specific resistance of 100 Ωm or below at 25° C., and the specific resistance at a switching temperature that Joule heat is generated due to the supply of current is preferably increased at least 10⁵ times as great as that at 25° C. In addition, the PTC element 110 should be designed to endure a voltage of AC 100V or above with keeping electrical and thermal stability and not to generate flashover when an over-voltage of 30 kV or above per 1 cm is applied. Moreover, when being put into a circuit, the PTC element 110 should not be tripped at the time that an ordinary current, for example about 1A is applied thereto. In addition, when an overcurrent more than 10 times of a normal operation current is applied, the PTC element 110 should cause a rise of resistance within ½ cycle (here, one cycle is 16.7 ms) at a frequency of 60 Hz to limit the overcurrent. Moreover, the PTC element 110 is preferably fabricated so that an operation time should be faster as a magnitude of a short circuit current is greater, and also it may restore its initial state within several minutes after the overcurrent limiting operation.

Preferably, the PTC element 110 has a plate structure, and it may have a circular, oval or polygonal shape. In addition, the present invention is not limited thereto, but its area and thickness are designed in consideration of use conditions of the PTC element 110, namely various factors such as an ordinary current, an overcurrent to be limited, and an operation time, as described later.

According to this embodiment, the PTC element 10 is preferably composed of polymer having PTC characteristics. In more detail, the PTC element 10 has a structure where conductive particles are impregnated in the polymer.

The polymer may be at least one polymer selected from the group consisting of HDPE (High Density Polyethylene), LDPE (Low Density Polyethylene), epoxy, silicone, and PVDF (Polyvinyl Difluoride). In addition, the conductive particles may have at least one type of conductive particles selected from the group consisting of carbon, metal and metal oxide. In addition, an antioxidant may be further added to prevent oxidization of the PTC polymer.

More preferably, an inorganic additive may be further added to the PTC polymer so as to improve a low resistance characteristic at a normal temperature and a high resistance characteristic at a high temperature further.

The contact electrodes 121, 131 include an upper contact electrode 121 and a lower contact electrode 131 installed to top and bottom contact surfaces of the PTC element 110, and they are adhered to the PTC element 110 as closely as possible so as to minimize a contact resistance.

The contact electrodes 121, 131 may be composed of copper foil or other metal elements. In addition, the contact electrodes 121, 131 are preferably installed in a way of reducing a contact resistance to the minimum by using lamination or free contact as examples.

At a short current fault, interfaces between the PTC element 110 and the contact electrodes 121, 131 may be separated by electron repelling force to cause arc and noise. If an arc is generated as mentioned above, the PTC element 110 is partially evaporated to form a conductive path, and flashover may be generated between the contact electrodes 121, 131 at both ends. In order to prevent the above, it is required to consider relations among the surface area of the PTC element 110, the surface area of the contact electrodes 121, 131, the thickness of the PTC element 110, and a rated voltage. These are explained in detail as follows.

First, the contact electrodes 121, 131 are designed to have a surface area smaller than that of the PTC element 110. By this configuration, an insulating distance between both ends of the contact electrodes 121, 131 can be increased to prevent flashover.

In addition, the PTC current limiting device according to the present invention is designed to satisfy the following equations 1 and 2 in addition to the above conditions.

$$\begin{matrix}\frac{V}{L} < 10 & Equation 1 \\ \frac{V}{b} < 50 & Equation 2\end{matrix}$$

As shown in FIG. 3, in the equations 1 and 2, L is a minimum value of the sum total of a distance a1 (mm) between an end of the upper contact electrode 121 and an end of the PTC element 110, a distance a2 (mm) between an end of the lower contact electrode 131 and the end of the PTC element 110, and a thickness b of the PTC element 110. In addition, V is a rated voltage (Volt) of the PTC current limiting device.

If the PTC element 110 and the contact electrodes 121, 131 are designed to satisfy the equations 1 and 2, the PTC current limiting device can conduct its current limiting action effectively without causing flashover between electrodes, as being understood by experimental examples described later.

Preferably, the PTC current limiting device further includes current leads 122, 132 for electrically connecting the contact electrodes 121, 131 to a power system. The current leads 122, 132 are extended so that their one ends are electrically connected to the contact electrodes and the other ends are connected to an external circuit. In addition, the current leads 122, 132 are preferably made of metal materials and also preferably have size and thickness conforming to an applicable capacity of the system current.

More preferably, the PTC current limiting device may further include a connection electrode (not shown) interposed between the contact electrodes 121, 131 and the current leads 122, 132. This connection electrode is made of metal with a relatively lower resistance so that a current can be more easily applied from the power system to the PTC current limiting device.

FIG. 4 shows a PTC current limiting device according to another embodiment of the present invention. In FIG. 4, the same reference numeral as in the former drawings designates the same component having the same function, and not described in detail.

Referring to FIG. 4, the PTC current limiting device of this embodiment further includes a pressing means for pressing the contact electrodes 121, 131 toward the PTC element 110. The pressing means includes a housing 440, and elastic members 451, 452.

The housing 160 receives the entire PTC element 110, the entire contact electrodes 121, 131, an a part of the current leads 122, 132. Thus, a part of the current leads 122, 132 is extended outward through the housing 440 and connected to a power system.

The elastic members 451, 452 are supported against an inner surface of the housing 440 and configured to surround the outer circumference of the current leads 122, 132 and press the current leads 122, 132 toward the contact electrodes 121, 131. Thus, the contact electrodes 121, 131 are pressed toward the PTC element 110. Preferably, the elastic members 451, 452 may be prepared to any or both of the pair of current leads 122, 132.

Meanwhile, the elastic members 451, 452 are preferably designed to have a pressing force of at least 1 bar so as to cope with the separation of interfaces between the PTC element 110 and the contact electrodes 121, 131 caused by electron repelling force generated at a short circuit fault. In addition, it is also preferable that the pressing force of 1 bar or above is kept even when the thickness of the PTC element 110 is decreased to a half due to repeated current limiting operations.

The elastic members 451, 452 may employ coil springs prepared to surround the outer circumference of the current lead 122 and/or 132, for example. However, the present invention is not limited to the above, and various changes may be used within the scope of the invention by those skilled in the art.

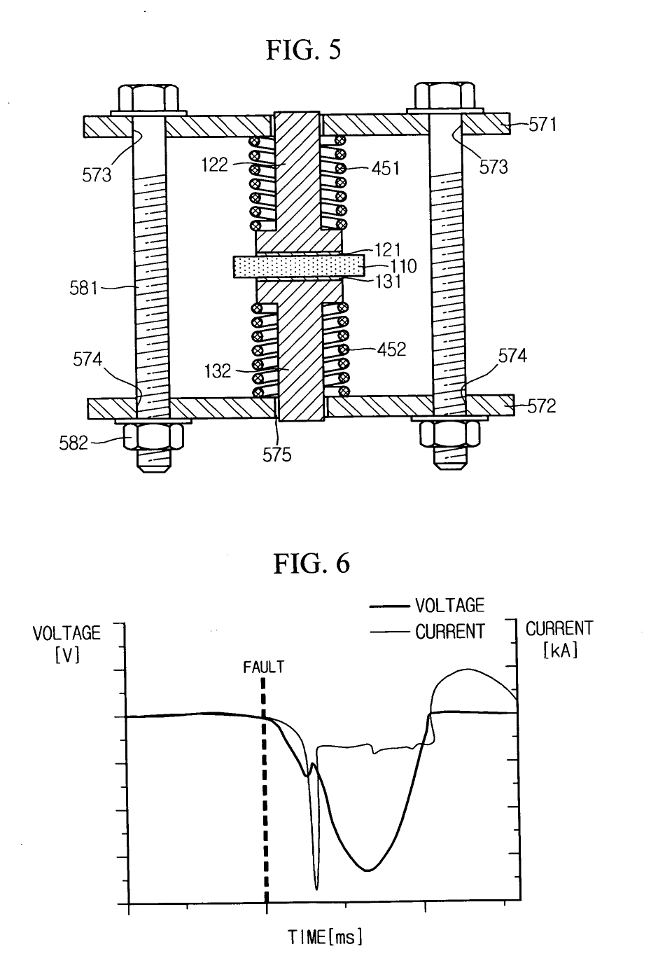

FIG. 5 shows a PTC current limiting device according to still another embodiment of the present invention. In FIG. 5, the same reference numeral as in the former drawings designates the same component having the same function, and not described in detail.

Referring to FIG. 5, the pressing means of the PTC current limiting device according to this embodiment includes upper and lower plates 571, 572, and a coupling member for coupling the upper and lower plates 571, 572.

The PTC element 110, the contact electrodes 121, 131, and the current leads 122, 132 are arranged between the upper and lower plates 571, 572, and the upper and lower plates 571, 572 have a through hole 575 at their center so that the current leads 122, 132 are connected to an external circuit.

The upper and lower plates 571, 572 have coupling holes 573, 574 in their edges, and thus the coupling members fix the upper and lower plates 571, 572 with each other through the coupling holes 573, 574. Specifically, bolts 581 pass through the coupling holes 573, 574, and nuts 582 are coupled to the bolts 581 to fix the upper and lower plates 571, 572 with each other.

Preferably, the pressing means further includes elastic members 451, 452 that surround the current leads 122, 132. The elastic members 451, 452 are supported against the inner side of the plates 571, 572, and they are compressed and elastically biased along the outer circumference of the current leads 122, 132. Accordingly, the contact electrodes 121, 131 press the PTC element 110. A pressing force of the elastic members 451, 452 is substantially identical to that of the former embodiment.

Meanwhile, FIG. 5 shows that the elastic members 451, 452 are arranged to both current leads 122, 132, but they may be arranged to any one of them when required.

Though the detailed configuration of the pressing means has been explained in detail in the above embodiments, the present invention is not limited thereto, but it should be understood that various changes of a pressing means capable of pressing the contact electrodes 121, 131 toward the PTC element 110 may be used.

Hereinafter, experimental examples are illustrated to facilitate better understanding of the present invention.

PTC current limiting devices were made with changing the diameter of the PTC element 110, the thickness of the PTC element 110 and diameters of the contact electrodes 121, 131 in various ways, and then a test voltage was changed to 100V to 500V. Detailed conditions of these experimental examples are shown in the following table 1.

TABLE 1

| | Diameter | Diameter | | Thickness | |
|---|---|---|---|---|---|
| | of PTC | of Contact | a1 | (b) of PTC | Test |
| | element | Electrode | (=a2) | element | Voltage |
| | (mm) | (mm) | (mm) | (mm) | (V) |
| Example 1 | 20 | 10 | 5 | 2.5 | 100 |
| Example 2 | 20 | 10 | 5 | 2.5 | 200 |
| Example 3 | 20 | 10 | 5 | 2.5 | 300 |
| Example 4 | 30 | 14 | 8 | 5 | 100 |
| Example 5 | 30 | 14 | 8 | 5 | 200 |
| Example 6 | 30 | 14 | 8 | 5 | 300 |
| Example 7 | 30 | 14 | 8 | 5 | 400 |
| Example 8 | 30 | 20 | 5 | 5 | 100 |
| Example 9 | 30 | 20 | 5 | 5 | 200 |
| Example 10 | 30 | 20 | 5 | 5 | 300 |
| Example 11 | 30 | 20 | 5 | 5 | 400 |
| Example 12 | 45 | 20 | 12.5 | 10 | 300 |
| Example 13 | 45 | 20 | 12.5 | 10 | 400 |
| Example 14 | 45 | 20 | 12.5 | 10 | 500 |
| Example 15 | 45 | 20 | 12.5 | 20 | 300 |
| Example 16 | 45 | 20 | 12.5 | 20 | 400 |
| Example 17 | 45 | 20 | 12.5 | 20 | 500 |

The following table 2 shows test results related to whether each experimental example satisfies the equations 1 and 2 and whether flashover is generated when the PTC current limiting devices made under the conditions of the table 1 were operated.

TABLE 2

| | V/(a1 + | | Satisfying Equations | Flashover between |
|---|---|---|---|---|
| | a2 + b) | V/b | 1 and 2 | Contact Electrodes |
| Example 1 | 8.0 | 40 | ∘ | x |
| Example 2 | 16.0 | 80 | x | ∘ |
| Example 3 | 24.0 | 120 | x | ∘ |
| Example 4 | 4.8 | 20 | ∘ | x |
| Example 5 | 9.5 | 40 | ∘ | x |
| Example 6 | 14.3 | 60 | x | ∘ |
| Example 7 | 19.0 | 80 | x | ∘ |
| Example 8 | 6.7 | 20 | ∘ | x |
| Example 9 | 13.3 | 40 | x | ∘ |
| Example 10 | 20.0 | 60 | x | ∘ |
| Example 11 | 26.7 | 80 | x | ∘ |
| Example 12 | 8.6 | 30 | ∘ | x |
| Example 13 | 11.4 | 40 | x | ∘ |
| Example 14 | 14.3 | 50 | x | ∘ |
| Example 15 | 6.7 | 15 | ∘ | x |
| Example 16 | 8.9 | 20 | ∘ | x |
| Example 17 | 11.1 | 25 | x | ∘ |

Seeing the table 2, it would be found that flashover is not generated between electrodes only when the equations 1 and 2 are satisfied.

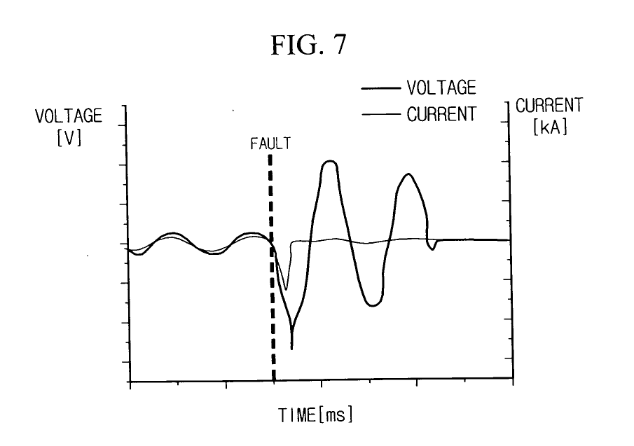

FIG. 6 is a graph showing an operation waveform of the PTC current limiting device when flashover is generated, and FIG. 7 is a graph showing an operation waveform of the PTC current limiting device when flashover is not generated.

Referring to FIG. 6, it would be understood that the PTC element trips after a fault, so a fault current is instantly decreased and then abruptly increased. This phenomenon is generated since an excessive voltage generated at both ends of the PTC element causes flashover between both electrodes and thus most of the fault current flows by means of the flashover. If the flashover is generated as mentioned above, the fault current instantly decreased is increased again, not allowing a proper current limiting action.

Referring to FIG. 7, it would be understood that the PTC element trips a certain time after the fault to limit the fault current, thereby ensuring insulation between both electrodes and thus not causing flashover between electrodes. Thus, the current limiting action of the PTC element is lasting, thereby limiting the fault current to a very low value.

If a PTC current limiting device is designed to satisfy the equations 1 and 2 by using the above experimental examples, it is possible to prevent flashover between the contact electrodes and thus ensure a proper current limiting action of the PTC element without a failure.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

As described above, the PTC current limiting device according to the present invention may prevent flashover generated between contact electrodes even in a high-voltage and large-current power system in consideration of a thickness factor of the PTC element as well as a surface area factor of the PTC element and the contact electrodes, so it may protect the power system against an overcurrent more effectively.

What is claimed is:

1. A PTC (Positive Temperature Coefficient) current limiting device, which limits a current using PTC characteristics, the device comprising:
a PTC element having the PTC characteristics; and
upper and lower contact electrodes arranged to face each other with the PTC element being interposed therebetween,
wherein, assuming that a distance from an end of the upper contact electrode to an end of the PTC element is a1, a distance from an end of the lower contact electrode to the end of the PTC element is a2, a thickness of the PTC element is b, and L=a1+a2+b, the following equations are satisfied:
$$\frac{V}{L} < 10 and \frac{V}{b} < 50$$
where V is a rated voltage of the PTC current limiting device, a unit for a1, a2 and b is mm, and a unit for V is volt.

2. The PTC current limiting device according to claim 1, further comprising upper and lower current leads connected to the upper and lower contact electrodes respectively to electrically connect the contact electrodes to a system circuit.

3. The PTC current limiting device according to claim 1, wherein the PTC element has a plate shape.

4. The PTC current limiting device according to claim 1, wherein the PTC element includes:
at lease one polymer selected from the group consisting of HDPE (High Density Polyethylene), LDPE (Low Density Polyethylene), epoxy, silicone, and PVDF (Polyvinyl Difluoride);
at least one type of conductive particles selected from the group consisting of carbon, metal and metal oxide; and
an antioxidant.

5. The PTC current limiting device according to claim 1, further comprising a pressing means for pressing the contact electrodes toward the PTC element.

6. The PTC current limiting device according to claim 5, wherein the pressing means gives a pressing force equal to or greater than an atmospheric pressure.

7. The PTC current limiting device according to claim 5, further comprising upper and lower current leads connected to the upper and lower contact electrodes respectively to electrically connect the contact electrodes to a system circuit,
wherein the pressing means includes:
a housing that receives the PTC element, the contact electrodes and the current leads; and
an elastic member elastically biased by an inner surface of the housing so as to press the current leads toward the PTC element.

8. The PTC current limiting device according to claim 5, further comprising upper and lower current leads connected to the upper and lower contact electrodes respectively to electrically connect the contact electrodes to a system circuit,
wherein the pressing means includes:
a pair of plates arranged so that the PTC element, the contact electrodes and the current leads are interposed therebetween; and
a coupling member for coupling and fixing the pair of plates with each other.

9. The PTC current limiting device according to claim 8, further comprising an elastic member elastically biased by an inner surface of the plates so as to press the current leads toward the PTC element.
